(19) United States
(12) Patent Application Publication
(10) Pub. No.: US 2006/0049963 A1
(43) Pub. Date: Mar. 9, 2006

(54) Smith alert system

(76) Inventor: Arthur E. Smith, Wylie, TX (US)

Correspondence Address: Arthur E. Smith, 602 Riva Ridge, Wylie, TX, 75098, US

(21) Appl. No.: 10/934,980

(22) Filed: Sep. 7, 2004

(51) Int. Cl. G08G 1/00; B60Q 1/00

(52) U.S. Cl. 340/902; 340/425.5

(57) ABSTRACT

This system relates to increasing the safety of public roadways and the reduction of accidents by making the vehicle operators more aware of their surroundings by using Radio Frequency Identification (RDIF) and specifically designated radio frequencies sent from stationary and or mobile transceivers to transponders mounted or incorporated into the vehicle. Definition List 1 Term: RFID Definition: Radio Frequency Identification Term: RFID Transceiver Definition: A stationary or mobile device that emits radio waves Term: RFID Transponder Definition: A stationary or mobile device that receives radio waves Term: RFID Transponder chip Definition: A small circuit board to control certain electronic functions in electrical appliances.

### BACKGROUND OF THE INVENTION

The continual population growth has contributed to the continual growth of vehicles on the public roadways.

The increase in vehicles on the public roadways contributes to the need for continual repair of existing roadways and construction of new roadways.

The population growth has also resulted in the need for more and more schools. As the schools increase, so does the need for more “school zones” and more school buses on the public roadways.

The increase in population creates an increase in consumer goods, which relates to increased roadway and rail transportation.

The increase in vehicle population on the public roadways results in more vehicular accidents, which also results in more emergency vehicles on the public roadways.

a Significant number of these accidents are related to “driver awareness”. Vehicle operators are easily distracted by:
Conversations with passengers
Children in vehicle
Cell phone
Audio equipment (radio, tape/CD player, CB radio, etc.)
Road signs and billboards
Navigation systems
etc.

There is a need for an operator alert system to make the vehicle operators more aware of their surroundings, which will increase the safety on the public roadways and reduce the number of accidents.

There is a need to increase the safety of children in school zones and while loading on or un-unloading off school buses.

There is a need to enhance the warning systems at railway intersections to reduce the number of train-auto accidents.

There is a need to increase the safety of workers that repair existing or construct new roadways.

There is a need to enhance the current method of alerting vehicle operators of approaching emergency vehicles.

There is a need to aid in the reduction of “red light” (traffic signals) running by alerting the vehicle operators that the light is about to change from green to red.

### SUMMARY

The system uses Radio Frequency Identification (RFID) similar to a RFID toll tag to communicate between a transceiver and a transponder.

Six (6) specifically designated radio frequencies are required, one (1) for each of the following features:
School Zones
School Buses
Railway Crossings
Construction Zones
Emergency Vehicles
Traffic Lights

Transceivers are incorporated into existing “School Zone” and “Railway Crossing” warning lights, and “Traffic” lights. In “Construction Zones”, transceivers are mounted in free standing containers. For “School Buses and Emergency Vehicles”, transceivers are mounted inside the vehicles.

Transponders are mounted in every vehicle that travels the roadways. (This includes all cars, trucks, buses, motorcycles, RVs, etc.)

The transponders and transceivers can be independent units for existing vehicles, and integrated into new vehicle designs as part of the vehicle's electronics package.

What is claimed is:

1. Radio Frequency Identification (RFID) Transponders mounted in every vehicle on the roadway will receive signals from RFID Transceivers.

2. For School Zones (Frequency 1):
The transceivers incorporated in the “flashing yellow lights”, or a free standing transceiver sends out a signal (frequency 1) that activates the transponders in approaching vehicles. Each transceiver sends out a signal for 300 feet in both directions. When the transceiver activates the transponder, a red LED flashes and a voice module repeats “Caution: School Zone” until the transponder is out of the school zone.

3. For School Buses (Frequency 2):
When school bus door opens, the transceiver mounted in the bus sends out a signal (frequency 2) that activates the transponders in approaching vehicles. The transceiver sends out a signal for 50 feet in both directions of the stopped bus. When the transceiver activates the transponder, a red LED flashes and a voice module repeats “Caution: School Bus Loading/Unloading” until the school bus door is shut again.

4. For Railway Crossings (Frequency 3):
The transceivers incorporated in the “flashing red lights” at the railway crossing and; the transceivers incorporated in the locomotive and all train cars sends out a signal (frequency 3) that activates the transponders in approaching vehicles. Each transceiver sends out a signal for 100 feet. Or, a free standing, self contained transceiver can be installed at railway crossings that do not have the flashing red light signal. When the transceiver activates the transponder, a red LED flashes and a voice module repeats “Caution: Railway Crossing” until the transponder is out of range (100 feet) of the transceivers.

5. For Construction Zones (Frequency 4):
A portable, free standing, self contained transceiver positioned at the beginning of the “Construction Zone” and every 100 feet thereafter sends out a signal (frequency 4) that activates the transponders in approaching vehicles. Each transceiver sends out a signal for 100 feet in the both directions. When the transceiver activates the transponder, a red LED flashes and a voice module repeats “Caution: Construction Zone” until the transponder is out of range (100 feet) of the transceivers.

6. For Emergency Vehicles (Frequency 5):
When the sirens and flashing lights are on, the transceivers mounted in the “Emergency Vehicle” sends out a signal (frequency 5) that activates the transponders in all vehicles. The transceiver sends out a signal for 100 feet in all directions of the emergency vehicle. When the transceiver activates the transponder, a red LED flashes and a voice module repeats “Caution: Emergency Vehicle Approaching” until the emergency vehicle has passed.

7. For Traffic Lights (Frequency 6):
The transceivers incorporated in the “Traffic Light” sends out a signal (frequency 6) that activates the transponders in approaching vehicles. Five (5) seconds before the green light changes to red, the transceiver sends out a signal for 50 feet. When the transceiver activates the transponder, a red LED flashes and a voice module repeats “Caution: Light Changing” until the light changes.

8. For Vehicle Installed Radios; Tape/CD Players; CB Radios; Cell Phones, and Portable Tape/CD Players. A RFID Transponder chip integrated into new designs of all vehicle installed radios, tape/CD players, CB radios, cell phones, portable radios and tape/CD players that will “mute” the device when it receives any of the six (6) specifically designated signals.
